(19) United States
(12) Patent Application Publication
(10) Pub. No.: US 2023/0304577 A1
(43) Pub. Date: Sep. 28, 2023

(54) PARKING BRAKE STRUCTURE

(71) Applicant: Honda Motor Co., Ltd., Tokyo (JP)

(72) Inventors: Hideki KUWANO, Tokyo (JP); Tomohiro SUZUKI, Tokyo (JP); Koshi NAKAMURA, Tokyo (JP); Takatoshi EBINUMA, Tokyo (JP)

(73) Assignee: Honda Motor Co., Ltd., Tokyo (JP)

(21) Appl. No.: 18/124,163

(22) Filed: Mar. 21, 2023

(30) Foreign Application Priority Data
Mar. 25, 2022 (JP) 2022-049961

(51) Int. Cl. F16H 63/34

(52) U.S. Cl. CPC F16H 63/3416

(57) ABSTRACT

A parking brake structure having a simple configuration that is reduced in the number of parts and weight, is provided. The parking brake structure is for use in a vehicle including a driving force transmission member and a rotation member. The driving force transmission member is configured to transmit a driving force of a power unit to a rear wheel. The rotation member is wound with the driving force transmission member while being fixed to the rear wheel. The parking brake structure includes a locking member configured to engage with the rotation member to prevent the rotation member from rotating. The rotation member has an outer circumferential end face that is formed with a plurality of protrusions and recesses between the protrusions adjacent to each other. The protrusions are used to engage with the driving force transmission member. The locking member is formed with a protrusion engageable with the recess.

### BACKGROUND

### 1. Technical Field

The present invention relates to a parking brake structure and, in particular, to a parking brake structure used in a parking brake that prevents a wheel from rotating during stop of the vehicle.

### 2. Description of the Background

Parking brakes that prevent a wheel from rotating during stop of the vehicle are conventionally known.

Patent Literature 1 discloses a disc-type wheel brake to be mounted to a rear wheel of a motorcycle. This rear wheel brake includes a brake caliper, which is used during usual driving, and a parking brake caliper, which prevents a rear wheel from rotating during stop of the motorcycle.

### CITATION LIST

### Patent Literature

Patent Literature 1: Japanese Patent No. 3848525

### BRIEF SUMMARY

Unfortunately, the parking brake caliper of Patent Literature 1 is configured to press pad members against a brake disc to generate friction, which complex structure tends to increase in the number of parts and weight.

An object of the present invention is to solve the problems in the existing technique described above and to provide a parking brake structure having a simple configuration that is reduced in the number of parts and weight.

In order to achieve the above object, a first aspect of the present invention provides a parking brake structure for use in a vehicle (1) including a driving force transmission member (17) and a rotation member (18). The driving force transmission member (17) is configured to transmit a driving force of a power unit (P) to a rear wheel (WR). The rotation member (18) is wound with the driving force transmission member (17) while being fixed to the rear wheel (WR). The parking brake structure includes a locking member (60) configured to engage with the rotation member (18) to prevent the rotation member (18) from rotating.

In a second aspect of the present invention, the rotation member (18) may have an outer circumferential end face that is formed with a plurality of protrusions (18a) and recesses (18b) between the protrusions (18a) adjacent to each other. In this case, the protrusions (18a) may be used to engage with the driving force transmission member (17), and the locking member (60) may be formed with a protrusion (61) engageable with the recess (18b).

In a third aspect of the present invention, the locking member (60) may be configured to move along a radial direction of the rotation member (18) to engage with the rotation member (18).

In a fourth aspect of the present invention, the vehicle (1) may include a swing arm (16) that axially supports the rear wheel (WR) in a rotatable manner while being axially supported to a vehicle body in a swingable manner. In this case, the locking member (60) may be disposed at a position overlapping a straight line (C) connecting a center of a pivot (14) of the swing arm (16) and a center of an axle (19) of the rear wheel (WR).

In a fifth aspect of the present invention, the parking brake structure may further include a swing member (31) that is coupled to a cable (38), and the locking member (60) may be configured to slide upon being pushed by the swing member (31) that swings in response to the cable (38) being pulled.

In a sixth aspect of the present invention, the cable (38) may be coupled to a side stand (76) of the vehicle (1), and the locking member (60) may be configured to engage with the rotation member (18) in response to the cable (38) being pulled in accordance with unfolding operation of the side stand (76).

In a seventh aspect of the present invention, a lost motion mechanism (50) using an elastic member (66) may be provided between the cable (38) and the locking member (60).

In an eighth aspect of the present invention, a plurality of the protrusions (61) may be provided.

In the first aspect of the present invention, the parking brake structure is for use in the vehicle (1) including the driving force transmission member (17) and the rotation member (18). The driving force transmission member (17) is configured to transmit the driving force of the power unit (P) to the rear wheel (WR). The rotation member (18) is wound with the driving force transmission member (17) while being fixed to the rear wheel (WR). The parking brake structure includes the locking member (60) configured to engage with the rotation member (18) to prevent the rotation member (18) from rotating. This structure makes it possible to set up a parking brake by using an existing rotation member for transmitting a driving force of a power unit, as it is, and by providing only the locking member for preventing the rotation member from rotating. Thus, compared with a structure having a parking brake caliper, it is possible to reduce the number of parts and weight of the structure.

In the second aspect of the present invention, the rotation member (18) has the outer circumferential end face that is formed with the plurality of protrusions (18a) and recesses (18b) between the protrusions (18a) adjacent to each other. In this case, the protrusions (18a) are used to engage with the driving force transmission member (17), and the locking member (60) is formed with a protrusion (61) engageable with the recess (18b). Thus, the parking brake can be set up by using a general shape rotation member, resulting in preventing an increase in the number of parts and in weight.

In the third aspect of the present invention, the locking member (60) is configured to move along the radial direction of the rotation member (18) to engage with the rotation member (18). Thus, the locking member engages with the rotation member from a radial outside, whereby rotation of the rear wheel is prevented by a small force. In addition, the locking member, which is positioned on a radial outside of the rotation member, does not increase the dimension in the vehicle-width direction.

In the fourth aspect of the present invention, the vehicle (1) includes the swing arm (16) that axially supports the rear wheel (WR) in a rotatable manner while being axially supported to the vehicle body in a swingable manner. In this case, the locking member (60) is disposed at a position overlapping the straight line (C) connecting the center of the pivot (14) of the swing arm (16) and the center of the axle (19) of the rear wheel (WR). Thus, the locking member is disposed at a position at which it easily engages with the rotation member, whereby rotation of the rear wheel can be prevented by a small force. Moreover, the locking member is mounted to the swing arm while being hidden thereby, resulting in improving an external appearance.

In the fifth aspect of the present invention, the parking brake structure further includes the swing member (31) that is coupled to the cable (38), and the locking member (60) is configured to slide upon being pushed by the swing member (31) that swings in response to the cable (38) being pulled. In this structure, an operation element for the parking brake is easily provided at a desired position of the vehicle body by routing a cable. With this structure, the parking brake can be actuated by operating, for example, a lever that is provided to a steering handlebar.

In the sixth aspect of the present invention, the cable (38) is coupled to the side stand (76) of the vehicle (1), and the locking member (60) is configured to engage with the rotation member (18) in response to the cable (38) being pulled in accordance with unfolding operation of the side stand (76). Under these conditions, the parking brake is actuated in response to operation to unfold the side stand, resulting in improving convenience.

In the seventh aspect of the present invention, the lost motion mechanism (50) using the elastic member (66) is provided between the cable (38) and the locking member (60). With this structure, the locking member is made to wait while being pushed against the rotation member by a biasing force of the elastic member, when the rotation member and the locking member fail to engage with each other although the cable is pulled.

In the eighth aspect of the present invention, the plurality of protrusions (61) are provided, whereby rotation of the rotation member is prevented by a smaller force.

### BRIEF DESCRIPTION OF DRAWINGS

FIG. 1 is a left side view of a motorcycle using a parking brake structure according to one embodiment of the present invention.

FIG. 2 is a left side view showing a structure of a parking brake according to the embodiment.

FIG. 3 is a plane view showing the structure of the parking brake.

FIG. 4 is a left side view showing a disengaged state between a locking member and a driven sprocket.

FIG. 5 is a left side view showing an operating state of a lost motion mechanism.

FIG. 6 is an enlarged perspective view of a steering handlebar on a left side in a vehicle-width direction of the motorcycle.

FIG. 7 is a rear view of a side stand in an unfolded state, as seen from a rear side of a vehicle body.

FIG. 8 is an enlarged side view showing a folded state of the side stand.

FIG. 9 is an enlarged side view showing the unfolded state of the side stand.

### DETAILED DESCRIPTION

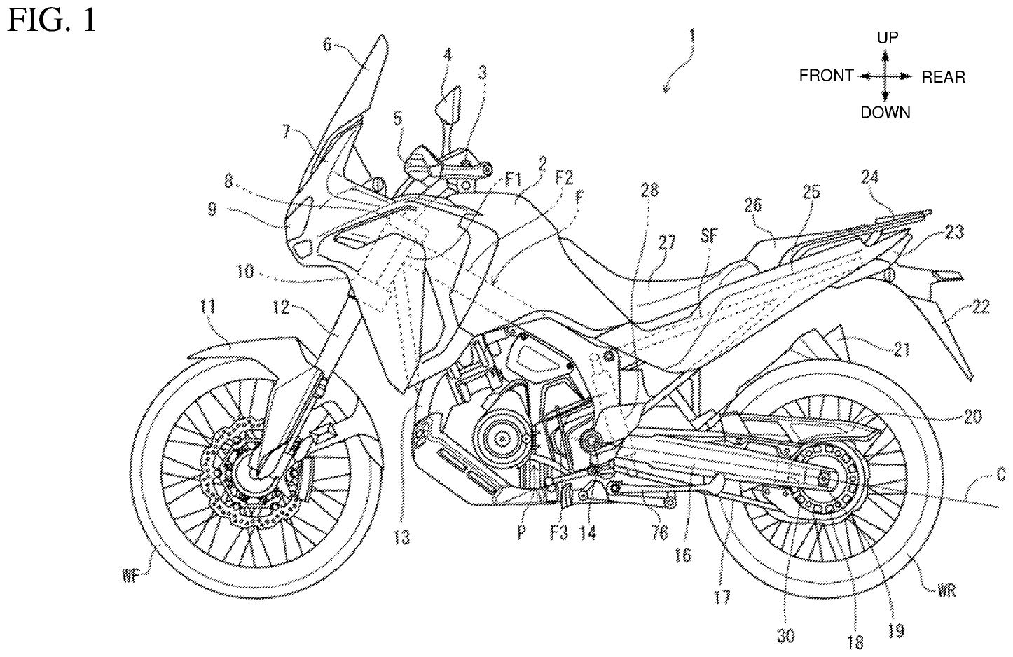

Preferred embodiments of the present invention will be described in detail with reference to the attached drawings, hereinafter. FIG. 1 is a left side view of a motorcycle 1 using a parking brake structure according to one embodiment of the present invention. The motorcycle 1 is a saddled vehicle that is driven by a driving force of a power unit P that is transmitted to a rear wheel WR by a drive chain 17. A main frame F2, which consists of paired right and left pipes, constitutes a vehicle body frame F and is provided with a head pipe F1 at a front end part. The head pipe F1 axially supports a steering stem (not shown) in a swingable manner.

A front fork 12, which consists of paired right and left pipes, axially supports a front wheel WF in a rotatable manner, and it is supported by a top bridge 8 and a bottom bridge 10 that are fixed to the steering stem, respectively, on an upper part and a lower part of the head pipe F1. A steering handlebar 3 is fixed to the top bridge 8 and is attached with paired right and left rear-view mirrors 4 and paired right and left knuckle guards 5. A front cowl 7 covers a front part of the steering handlebar 3 and supports a headlight 9 and a windshield screen 6. A front fender 11 that covers an upper part of the front wheel WF is fixed to the front fork 12. The power unit P is suspended at a lower part of the main frame F2. Combustion gas from the power unit P is discharged from a muffler 21 on a right side in the vehicle-width direction, via an exhaust pipe 13.

The main frame F2 is coupled to a pivot frame F3 at a rear end lower part. The pivot frame F3 is composed of paired right and left pipes that support a pivot 14 of a swing arm 16. The pivot 14 axially supports a front end part of the swing arm 16 in a swingable manner. The swing arm 16 axially supports the rear wheel WR in a rotatable manner and is suspended to the main frame F2 by a rear cushion 28, at a rear position of the pivot 14. A side stand 76, which holds the vehicle body in an inclined state during stop of the vehicle, is axially supported in a swingable manner under the pivot frame F3. A driven sprocket 18 being a rotation member is fixed to the rear wheel WR and is wound with a drive chain 17, which is a driving force transmission member. A chain cover 20 is attached at an upper part of the swing arm 16 and covers an upper part of the drive chain 17.

A fuel tank 2 is disposed on an upper part of the main frame F2, and a seat frame SF extending upward toward a rear side is coupled to a rear part of the main frame F2. A front seat 27 and a rear seat 26 that are supported by the seat frame SF are disposed on a rear side of the fuel tank 2. A rear cowl 25 covers an outer side in the vehicle-width direction of the seat frame SF, and a rear carrier 24 that is supported by the seat frame SF is disposed on an outer side in the vehicle-width direction of the rear seat 26. The rear cowl 25 is provided with a tail light unit 23 and a rear fender 22 at a rear part.

The parking brake 30 of this embodiment includes a slide locking member configured to engage with protrusion shapes and recess shapes formed on an outer circumferential end face of the driven sprocket 18. The locking member is engaged with the driven sprocket 18, whereby the rear wheel WR is prevented from rotating. The parking brake 30 is disposed on an inside surface of a left arm, which is one of paired right and left arms constituting the swing arm 16, at a position overlapping a straight line C connecting the center of the pivot 14 of the swing arm 16 and the center of an axle 19 of the rear wheel WR.

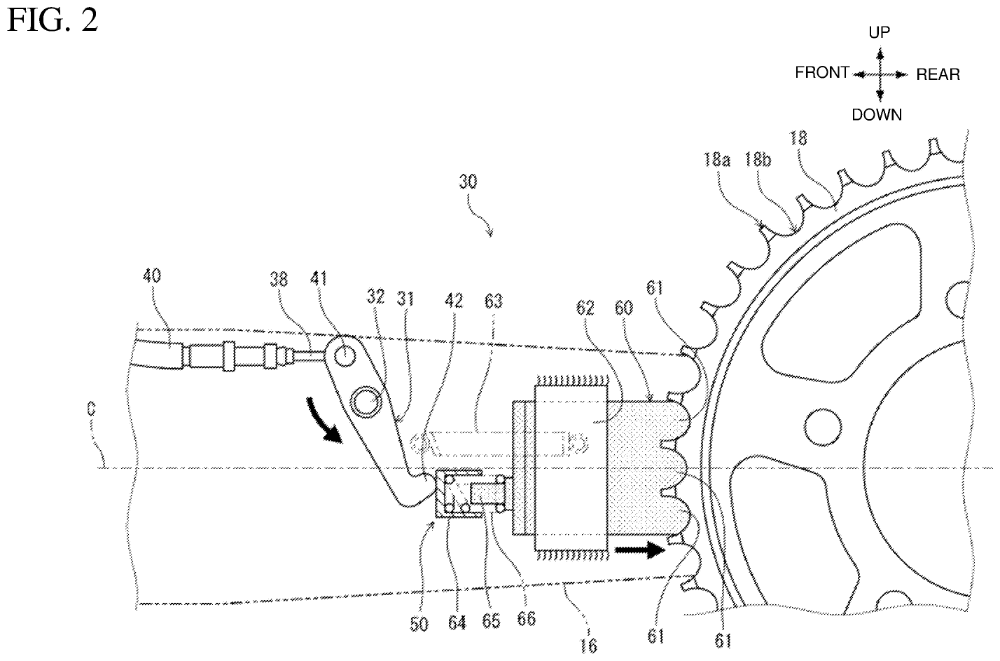

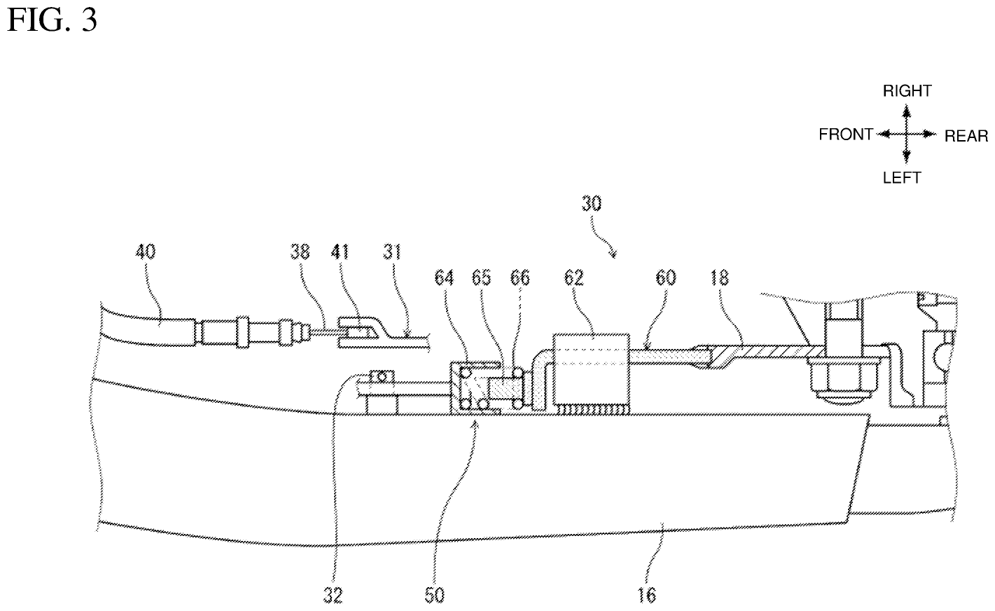

FIG. 2 is a left side view showing a structure of the parking brake 30 of this embodiment. In addition, FIG. 3 is a plane view showing the structure of the parking brake 30. The driven sprocket 18 has a plurality of sprocket teeth 18a that are formed as protrusions, around which the drive chain 17 is wound, and a recess 18b is formed between two adjacent sprocket teeth 18a. The parking brake 30 is configured to prevent the driven sprocket 18 from rotating, by using a locking member 60 (dot-hatched part in the drawings) that is formed with protrusions 61 to be engaged with the recesses 18b. The driven sprocket 18 is a plate member with a thickness of approximately 6 to 8 mm. The locking member 60, which is configured to engage with the recesses 18b, is made of a plate member with a thickness that is equal to or greater than that of the driven sprocket 18. The locking member 60, which has a thickness equal to or greater than that of the driven sprocket 18, is able to reduce adverse effects of dimensional variations, backlashes, and so on.

The locking member 60 engages with a support 62, which is fixed on the inside surface of the swing arm 16, in a manner slidable in the front-rear direction. More specifically, the locking member 60 is configured to slide forward and rearward along the straight line C connecting the center of the pivot 14 of the swing arm 16 and the center of the axle 19 of the rear wheel WR. The locking member 60 engages with a return spring 63 for applying a biasing force in a direction to return it to an initial position.

On the other hand, a swing shaft 32 is provided to stand from the inside surface of the swing arm 16 and axially supports a swing member 31 in a swingable manner. One end part of the swing member 31 engages with a cable end 41 of the inner cable 38, whereas the other end part of the swing member 31 is formed with a pushing part 42 for pushing the locking member 60. An outer cable 40 covers the inner cable 38 and is fixed to the inside surface of the swing arm 16. FIGS. 2 and 3 show a state in which the swing member 31 swings in a counterclockwise direction in the drawings in response to the inner cable 38 being pulled, and the locking member 60 slides in a right direction in the drawings, thereby preventing the driven sprocket 18 from rotating.

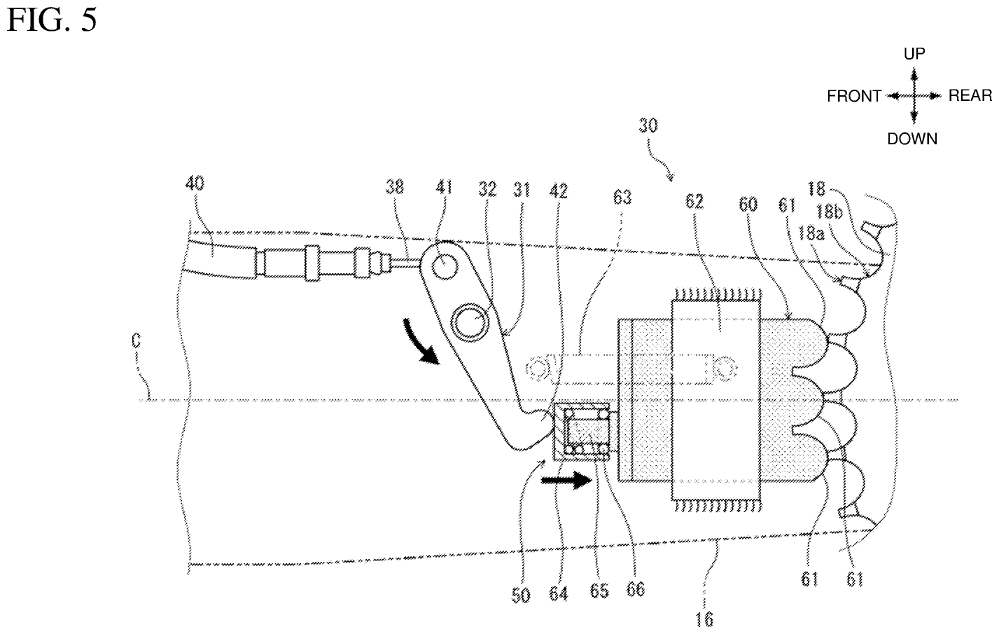

A lost motion mechanism 50 is assembled between the swing member 31 and the locking member 60. The lost motion mechanism 50 includes a lost motion spring 66, a support 65, and a tappet 64. The lost motion spring 66 is made of an elastic member, such as a coil spring. The support 65 is provided to stand at a front part of the locking member 60 and supports an end of the lost motion spring 66. The tappet 64 covers the other end of the lost motion spring 66. The lost motion mechanism 50 operates when the protrusions 61 of the locking member 60 fail to engage with the recesses 18b due to being in contact with the sprocket teeth 18a, although the inner cable 38 is pulled (refer to FIG. 5).

The parking brake 30 is disposed at a position overlapping the swing arm 16 in a vehicle side view. Thus, the swing member 31 and the locking member 60 are hidden by the swing arm 16, which structure improves an external appearance in a vehicle side view and protects the parking brake 30 from stones, etc., flying from a side of the vehicle body.

The locking member 60 of this embodiment has three protrusions 61. This structure enables preventing the driven sprocket 18 from rotating, by a smaller force than that in a case of having one protrusion 61, for example. The locking member 60 moves along a radial direction of the driven sprocket 18 to engage with the driven sprocket 18. Thus, the locking member 60 engages with the driven sprocket 18 from a radial outside, whereby rotation of the rear wheel WR is prevented by a small force. In addition, the locking member 60, which is positioned on a radial outside of the driven sprocket 18, does not increase the dimension in the vehicle-width direction.

Moreover, the locking member 60 is disposed at a position overlapping the straight line C connecting the center of the pivot 14 of the swing arm 16 and the center of the axle 19 of the rear wheel WR. Thus, the locking member 60 is disposed at a position at which it easily engages with the driven sprocket 18, whereby rotation of the rear wheel WR can be prevented by a small force. In addition, the locking member 60 at this position is hardly affected by variations in distance between the pivot 14 of the swing arm 16 and the axle 19 of the rear wheel WR due to adjustment of a chain adjuster.

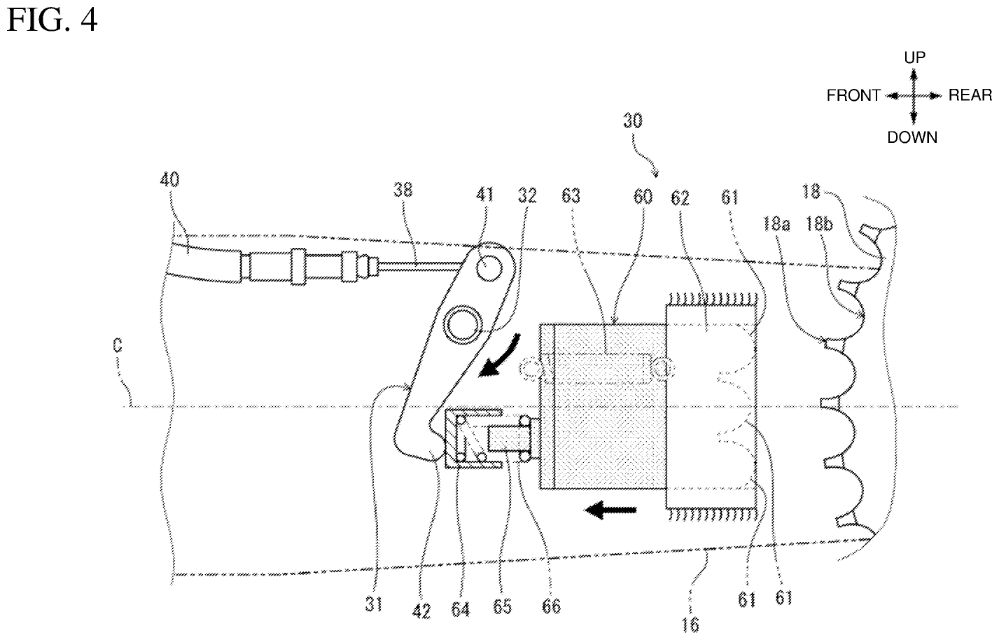

FIG. 4 is a left side view showing a disengaged state between the locking member 60 and the driven sprocket 18. In response to reduction in force of pulling the inner cable 38, the locking member 60 is slid in a left direction in the drawing by the biasing force of the return spring 63, and the swing member 31 is swung in a clockwise direction in the drawing. Thus, the protrusions 61 and the recesses 18b are disengaged from each other, and the parking brake 30 is released.

FIG. 5 is a left side view showing an operating state of the lost motion mechanism 50. As shown in the drawing, the lost motion mechanism 50 operates when the protrusions 61 fail to engage with the recesses 18b due to being in contact with the sprocket teeth 18a, although the inner cable 38 is pulled to swing the swing member 31 in the counterclockwise direction in the drawing. In this state, the locking member 60 is applied with a biasing force of the lost motion spring 66 and is able to engage with the recesses 18b instantaneously after the driven sprocket 18 rotates slightly.

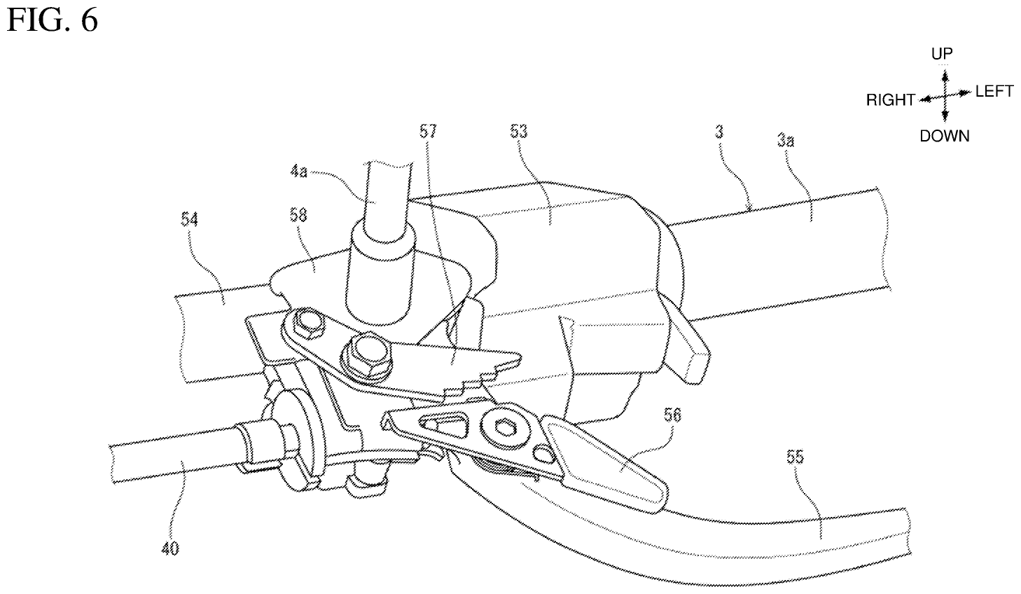

FIG. 6 is an enlarged perspective view of the steering handlebar 3 on a left side in the vehicle-width direction of the motorcycle 1. This drawing shows the steering handlebar 3 as seen from a front side of the vehicle body. In this embodiment, a lever 55, which is an operation element for the locking member 60, is attached to the steering handlebar 3 on the left side in the vehicle-width direction. A handle bar 54 is mounted with a lever support 58 that supports the lever 55, a handle switch 53, and a handle grip 3a. The lever support 58 is mounted with the outer cable 40 for operating the locking member 60, a stay 4a of the rear-view mirror 4, and a stopper base 57. Under these conditions, in response to a driver who holds the handle grip 3a grasping the lever 55, the locking member 60 engages with the driven sprocket 18 to lock the parking brake 30. In this state, a stopper lever 56, which is provided to the lever 55, is pushed to be engaged with the stopper base 57, whereby the position of the lever 55 is retained.

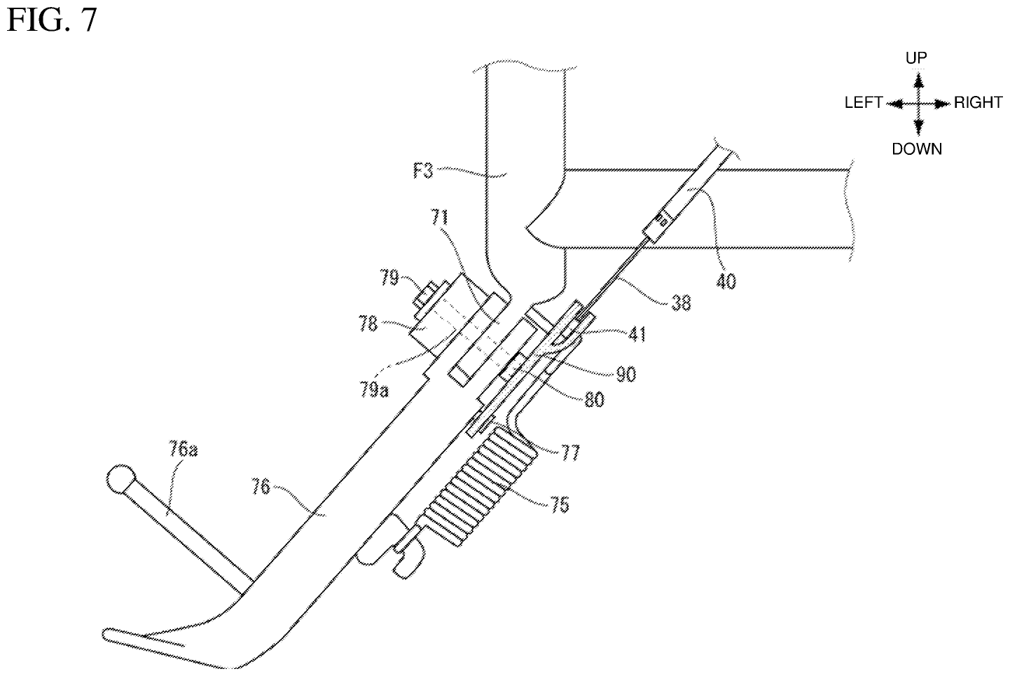

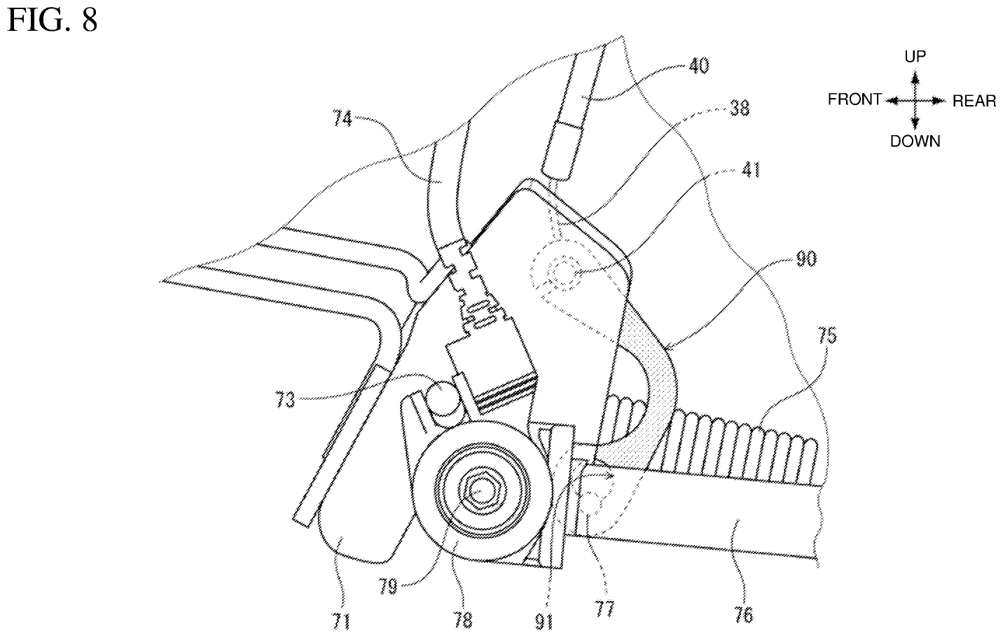

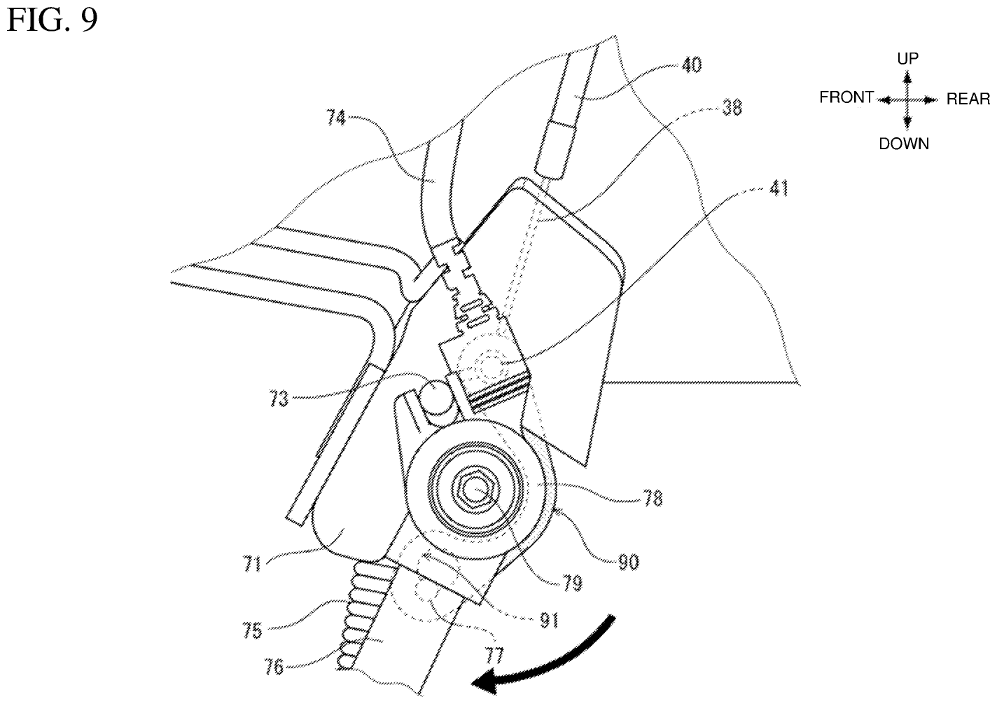

FIG. 7 is a rear view of the side stand 76 in an unfolded state, as seen from a rear side of the vehicle body. FIG. 8 is an enlarged side view showing a folded state of the side stand 76. FIG. 9 is an enlarged side view showing the unfolded state of the side stand 76. FIG. 6 shows a structure of the parking brake 30 actuated by using the lever 55, whereas FIGS. 7 to 9 show a structure of the parking brake 30 actuated in response to operation to unfold the side stand 76.

The side stand 76, which holds the vehicle body in an inclined state during stop of the vehicle, is provided on a left side in the vehicle-width direction of the motorcycle 1. In order to unfold the side stand 76, a control bar 76a is pushed down against a biasing force of a spring member 75 by the driver's foot. The side stand 76 is axially supported in a rotatable manner to a downwardly extended part 71 that is provided to the pivot frame F3 on a left side in the vehicle-width direction. The side stand 76 is tightened and fixed to the downwardly extended part 71 together with a side stand angle sensor 78 by a bolt 79 and a nut 80. The bolt 79 has a shank 79a that functions as a rotation shaft of the side stand 76. In addition, the side stand angle sensor 78 engages with a rotation preventing protrusion 73 and is connected to a wire 74 that outputs a sensor signal.

The outer cable 40 for operating the locking member 60 is routed to a back side of the side stand 76, and the cable end 41 of the inner cable 38 is coupled to an upper end part of a coupling member 90 (dot-hatched part in the drawings), which is formed of a plate member having a curved shape. On the other hand, a lower end part of the coupling member 90 engages with a pin 77 having a T-shaped cross section, which is provided to a back surface of the side stand 76. An engaging hole 91 is provided at the lower end part of the coupling member 90 and has a gourd shape in which a large diameter part and a small diameter part are combined. The large diameter part allows a head of the pin 77 to pass therethrough. The small diameter part engages with a shank of the pin 77.

With this structure, in response to the side stand 76 being unfolded, the inner cable 38 is pulled via the coupling member 90, resulting in actuating the parking brake 30. This further improves convenience of the motorcycle 1. In this embodiment, using the curved coupling member 90 enables the inner cable 38 to not come into contact with the rotation shaft 79a of the side stand 76 and the nut 80 screwed to the rotation shaft 79a and to be prevented from wearing.

As described above, the parking brake structure of the present invention includes the locking member 60 configured to engage with the driven sprocket 18 to prevent it from rotating. This structure makes it possible to set up the parking brake 30 by using the existing driven sprocket 18 for transmitting the driving force of the power unit P, as it is, and by providing only the locking member 60. Thus, compared with a structure having a parking brake caliper, it is possible to reduce the number of parts and weight of the structure.

The above-described embodiments are not intended to limit the type of the motorcycle, the shapes and structures of the drive chain and the driven sprocket, the shapes and structures of the swing member and the locking member, the structure of the lost motion mechanism, etc., and various modifications and changes can be made thereto. For example, the locking member may be used to prevent a drive sprocket on a driving side from rotating, and the locking member may be moved by a hydraulic system. In addition, the number of the protrusions of the locking member may be one or more. In another example, the parking brake may be actuated in response to operation to unfold a center stand that is configured to maintain the vehicle body in an upright state. The parking brake structure of the present invention is not limited to motorcycles, and it can be used in various vehicles such as three-wheeled vehicles and four-wheeled vehicles that transmit a driving force by a drive chain or a drive belt.

### REFERENCE SIGNS LIST

1 . . . motorcycle (vehicle), 14 . . . pivot, 16 . . . swing arm, 17 . . . drive chain (driving force transmission member), 18 . . . driven sprocket (rotation member), 18a . . . protrusion, 18b . . . recess, 19 . . . axle of a rear wheel, 31 . . . swing member, 38 . . . inner cable, 50 . . . lost motion mechanism, C . . . straight line connecting a center of a pivot of a swing arm and a center of an axle of a rear wheel, 60 . . . locking member, 61 . . . protrusion, 66 . . . lost motion spring (elastic member), 76 . . . side stand, P . . . power unit, WR . . . rear wheel

What is claimed is:

1. A parking brake structure for use in a vehicle including a driving force transmission member and a rotation member, the driving force transmission member being configured to transmit a driving force of a power unit to a rear wheel, the rotation member being wound with the driving force transmission member while being fixed to the rear wheel,
the parking brake structure comprising a locking member configured to engage with the rotation member to prevent the rotation member from rotating.

2. The parking brake structure according to claim 1, wherein the rotation member has an outer circumferential end face that is formed with a plurality of protrusions and recesses between the protrusions adjacent to each other, the protrusions are used to engage with the driving force transmission member, and
the locking member is formed with a protrusion engageable with the recess.

3. The parking brake structure according to claim 1, wherein the locking member is configured to move along a radial direction of the rotation member to engage with the rotation member.

4. The parking brake structure according to claim 1, wherein the vehicle includes a swing arm that axially supports the rear wheel in a rotatable manner while being axially supported to a vehicle body in a swingable manner, and
the locking member is disposed at a position overlapping a straight line connecting a center of a pivot of the swing arm and a center of an axle of the rear wheel.

5. The parking brake structure according to claim 1, further comprising a swing member that is coupled to a cable,
the locking member being configured to slide upon being pushed by the swing member that swings in response to the cable being pulled.

6. The parking brake structure according to claim 5, wherein the cable is coupled to a side stand of the vehicle, and
the locking member is configured to engage with the rotation member in response to the cable being pulled in accordance with unfolding operation of the side stand.

7. The parking brake structure according to claim 5, wherein a lost motion mechanism using an elastic member is provided between the cable and the locking member.

8. The parking brake structure according to claim 1, wherein a plurality of the protrusions are provided.

9. The parking brake structure according to claim 2, wherein the locking member is configured to move along a radial direction of the rotation member to engage with the rotation member.

10. The parking brake structure according to claim 2, wherein the vehicle includes a swing arm that axially supports the rear wheel in a rotatable manner while being axially supported to a vehicle body in a swingable manner, and
the locking member is disposed at a position overlapping a straight line connecting a center of a pivot of the swing arm and a center of an axle of the rear wheel.

11. The parking brake structure according to claim 3, wherein the vehicle includes a swing arm that axially supports the rear wheel in a rotatable manner while being axially supported to a vehicle body in a swingable manner, and
the locking member is disposed at a position overlapping a straight line connecting a center of a pivot of the swing arm and a center of an axle of the rear wheel.

12. The parking brake structure according to claim 2, further comprising a swing member that is coupled to a cable,
the locking member being configured to slide upon being pushed by the swing member that swings in response to the cable being pulled.

13. The parking brake structure according to claim 3, further comprising a swing member that is coupled to a cable,
the locking member being configured to slide upon being pushed by the swing member that swings in response to the cable being pulled.

14. The parking brake structure according to claim 4, further comprising a swing member that is coupled to a cable,
the locking member being configured to slide upon being pushed by the swing member that swings in response to the cable being pulled.

15. The parking brake structure according to claim 6, wherein a lost motion mechanism using an elastic member is provided between the cable and the locking member.

16. The parking brake structure according to claim 2, wherein a plurality of the protrusions are provided.

17. The parking brake structure according to claim 3, wherein a plurality of the protrusions are provided.

18. The parking brake structure according to claim 4, wherein a plurality of the protrusions are provided.

19. The parking brake structure according to claim 5, wherein a plurality of the protrusions are provided.

20. The parking brake structure according to claim 6, wherein a plurality of the protrusions are provided.
